(19) United States
(12) Patent Application Publication
(10) Pub. No.: US 2026/0252660 A1
(43) Pub. Date: Aug. 27, 2026

(54) Combinatorial Optimization Problem Processor and Method

(71) Applicant: Nippon Telegraph and Telephone Corporation, Tokyo (JP)

(72) Inventor: Toshiya Sato, Musashino-shi, Tokyo (JP)

(21) Appl. No.: 18/994,281

(22) PCT Filed: Jul. 19, 2022
(86) PCT No.: PCT/JP2022/028042

§ 371 Date: Jan. 14, 2025

(51) Int. Cl. G06F 17/11

(52) U.S. Cl. CPC G06F 17/11

(57) ABSTRACT

A combination optimization problem processing device that processes a combination optimization problem of N elements in association with an Ising model includes: a 1×2 Mach-Zehnder optical modulator that modulates a polarization clock pulse train; an optical interference circuit that inputs the polarization clock pulse train modulated by the 1×2 Mach-Zehnder optical modulator and causes a predetermined interaction in the Ising model to occur in a cycle of N pulses of the polarization clock pulse train; an optical signal processing unit that causes each pulse of the polarization clock pulse train to transition with respect to an optical power level according to a power level of each pulse of an optical signal pulse train output from the optical interference circuit; and a modulation signal generation unit that generates a modulation signal of the 1×2 Mach-Zehnder optical modulator and outputs a monitor signal.

### TECHNICAL FIELD

The present invention relates to a combination optimization problem processing device that derives a solution of a combination optimization problem and a method thereof.

### BACKGROUND ART

The combination optimization problem is a problem of searching for a combination (solution) of parameters that maximizes (or minimizes) an evaluation index among given conditions. The combination optimization problem can be applied to an aspect in which better selection is required in various fields such as delivery and drug discovery.

An NP-hard class combination optimization problem has a problem that, since the number of combinations exponentially increases as the number of elements (number of parameters) N of the combination increases, it takes an unrealistic long time to obtain an optimal solution in a “brute-force method”.

It is known that there is a correspondence relationship between solving a combination optimization problem and obtaining a most stable energy state of an Ising model. Non Patent Literature 1 discloses a method of substantially solving a combination optimization problem by finding a most stable energy state by mounting a method of finding a most stable state in an Ising model by a method according to simulated annealing on a CMOS semiconductor chip and performing a simulation.

However, the conventional method has a problem that it takes time to obtain an optimum solution. Therefore, the inventor has devised a combination optimization problem processing device and a method thereof capable of obtaining an optimal solution of a combination optimization problem in a shorter time than conventional methods (Patent Literature 1 and Patent Literature 2).

### CITATION LIST

### Patent Literature

Patent Literature 1: WO 2021/130800 A
Patent Literature 2: WO 2021/130814 A

### Non Patent Literature

Non Patent Literature 1: Masao Yamaoka and four other persons, “Shakai system no saitekika ni shisuru CMOS Ising keisanki (in Japanese) (CMOS Ising Calculator for Optimizing Social Systems)”, Hitachi Review, Vol. 99, No. 03, pp. 328-329

### SUMMARY OF INVENTION

### Technical Problem

In Patent Literatures 1 and 2, a coefficient J_{i:k} representing magnitude of an interaction is an important parameter that affects a characteristic of obtaining a better solution (corresponding to a stable state), and in a region where a sum of J_{i:k} does not exceed 1, it is expected that a better solution that reflects a mutual relationship more strongly can be obtained as an absolute value of J_{i:k} is qualitatively larger.

However, when a system in which N=100, total coupling, the absolute value of J_{i:k} is constant, and ferromagnetic and antiferromagnetic interactions are randomly allocated is taken as an example, it has been found that a phenomenon appears in which a substantially good solution is obtained up to the vicinity of 0.004 in the absolute value of J_{i:k}, but a good solution cannot be obtained at all when the absolute value of J_{i:k} increases up to the vicinity of 0.009.

The present invention has been made in view of the above, and an object of the present invention is to provide a combination optimization problem processing technique capable of obtaining a solution even in a region where interaction is large.

### Solution to Problem

A combination optimization problem processing device according to one aspect of the present invention is a combination optimization problem processing device that processes a combination optimization problem of N elements in association with an Ising model, the combination optimization problem processing device including: a 1×2 Mach-Zehnder optical modulator that inputs and modulates a polarization clock pulse train; an Ising model calculation unit that inputs the polarization clock pulse train modulated by the 1×2 Mach-Zehnder optical modulator and causes a predetermined interaction in the Ising model to occur in a cycle of N pulses of the polarization clock pulse train; an optical signal processing unit that inputs an optical signal pulse train and the polarization clock pulse train output from the Ising model calculation unit, and outputs an optical signal in which each pulse of the polarization clock pulse train has transitioned with respect to optical power according to a power level of each pulse of the input optical signal pulse train; and a modulation signal generation unit that shapes a waveform of an electrical signal obtained by photoelectrically converting the optical signal after the transition to generate a modulation signal of the 1×2 Mach-Zehnder optical modulator, and outputs a monitor signal representing a solution of the optimization problem to an outside, in which the Ising model calculation unit inputs an initialization optical pulse train in which effective peak power is ½ of the polarization clock pulse train and the number of pulses is N, creates a neutral state with respect to an interaction between the elements, and repeatedly causes the predetermined interaction in the Ising model from the neutral state in the cycle of N pulses of the polarization clock pulse train.

A combination optimization problem processing device according to one aspect of the present invention is a combination optimization problem processing device that processes a combination optimization problem of N elements in association with an Ising model, the combination optimization problem processing device including: a differential phase modulation-type Mach-Zehnder optical modulator that includes a first phase modulation unit and a second phase modulation unit, and inputs and modulates a polarization clock pulse train; an Ising model calculation unit that inputs the polarization clock pulse train modulated by the differential phase modulation-type Mach-Zehnder optical modulator, causes a predetermined interaction in the Ising model to occur in a cycle of N pulses of the polarization clock pulse train, and outputs a monitor signal representing a solution of the optimization problem to an outside; a multiplexer/demultiplexer that receives, as inputs, N initialization optical pulses that create a neutral state for an interaction between the elements and an optical signal pulse train output from the Ising model calculation unit, couples the initialization optical pulse to an output signal from the optical interference circuit, demultiplexes the initialization optical pulse and the optical signal pulse train, outputs one of the demultiplexed initialization optical pulse and optical signal pulse train to the first phase modulation unit as a first phase modulation signal, and outputs the other of the demultiplexed initialization optical pulse and optical signal pulse train to a delay unit as a second phase modulation signal; and a delay unit that delays the second phase modulation signal with respect to the first phase modulation signal by a time equal to or more than a pulse width of a pulse of the polarization clock pulse train and less than a pulse interval and outputs the second phase modulation signal to the second phase modulation unit, in which an optical signal processing unit that inputs the optical signal pulse train and the polarization clock pulse train output from the Ising model calculation unit and outputs an optical signal in which each pulse of the polarization clock pulse train has transitioned with respect to an optical power level according to a power level of each pulse of the input optical signal pulse train is provided in one of between the Ising model calculation unit and the multiplexer/demultiplexer, between the multiplexer/demultiplexer and the delay unit, or between the delay unit and the differential phase modulation-type Mach-Zehnder optical modulator.

### Advantageous Effects of Invention

According to the present invention, it is possible to provide a combination optimization problem processing technique capable of obtaining a solution even in a region where interaction is large.

### BRIEF DESCRIPTION OF DRAWINGS

FIG. 1 is a diagram illustrating an example of an Ising model.

FIG. 2 is a diagram schematically illustrating an example of a combination optimization problem.

FIG. 3 is a diagram illustrating an example of a configuration of a combination optimization problem processing device according to a first embodiment.

FIG. 4 is a time chart for describing a relationship between a polarization clock pulse train and each series.

FIG. 5 is a diagram illustrating an example of a configuration of an optical interference circuit.

FIG. 6 is a diagram illustrating an example of a configuration of an optical signal processing unit.

FIG. 7 is a diagram illustrating an example in which optical signal processing units are connected in a cascade.

FIG. 8 is a diagram illustrating an example of a configuration of a combination optimization problem processing device according to a second embodiment.

FIG. 9 is a diagram illustrating an example of a configuration of a differential phase modulation-type Mach-Zehnder optical modulator 60.

FIG. 10 is a diagram illustrating a relationship among an initialization optical pulse, a first phase modulation signal, a second phase modulation signal, and a polarization clock pulse train.

FIG. 11 is a diagram illustrating an example of a configuration of a functional circuit unit having a function similar to an optical interference circuit.

FIG. 12 is a graph of a change in output optical signal peak power with respect to a step of a comparative example.

FIG. 13 is a graph illustrating an appearance frequency focusing on Ising energy of a search solution of the comparative example.

FIG. 14 is a graph of a change in output optical signal peak power with respect to a step of the comparative example.

FIG. 15 is a graph illustrating an appearance frequency focusing on Ising energy of a search solution of the comparative example.

FIG. 16 is a graph of a change in output optical signal peak power with respect to a step of the present embodiment.

FIG. 17 is a graph illustrating an appearance frequency focusing on Ising energy of a search solution of the present embodiment.

### DESCRIPTION OF EMBODIMENTS

Before describing embodiments of the present invention, an Ising model and a combination optimization problem will be briefly described.

### (Ising Model)

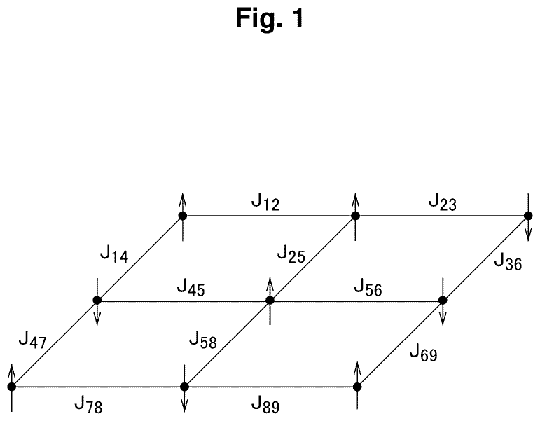

FIG. 1 illustrates an example of the Ising model. The Ising model is a model on statistical mechanics representing properties of a magnetic body (a ferromagnetic body, an antiferromagnetic body, or the like). The Ising model includes lattice points that take either an up spin state or a down spin state, and is in a stable state in a case where energy H considering an interaction between adjacent lattice points is the lowest.

In numerical calculation using a technique such as a neural network, the Ising model can be expressed by an interaction coefficient Jᵢⱼ representing a spin state σᵢ of each lattice point and a force of an interaction between two spins, and an external magnetic field coefficient hᵢ representing a force of a magnetic field applied from an outside. The energy H of the Ising model can be expressed by the following equation.

$$\begin{matrix}[ Math . 1 ] & \\ H = - {\sum }_{〈 i , j 〉} {J}_{i , j {σ}_{i} {σ}_{j}} - {\sum }_{j} {h}_{j} {σ}_{j} & ( 1 )\end{matrix}$$

n the Ising model, the spin state is updated so that the energy H is minimized. By mapping the combination optimization problem such that an evaluation index of the problem corresponds to the energy of the Ising model and converging the Ising model, a combination of spin states that minimizes the energy can be obtained. This means obtaining a combination of parameters that minimizes the evaluation index of the original optimization problem.

Note that, in an optimization simulator generally referred to as an Ising model machine, expansion is performed in consideration of not only interactions between adjacent lattice points but also interactions between all lattice points.

### (Combination Optimization Problem)

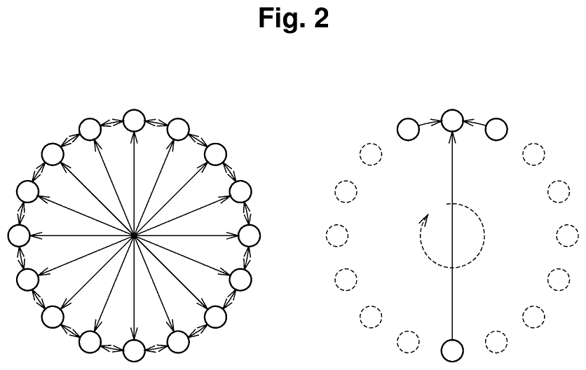

FIG. 2 is a diagram schematically illustrating an example of a combination optimization problem called a max-cut 3 problem with N=16. O illustrated in FIG. 2 represents each element of N=16.

The max-cut 3 problem is a problem that maximizes a total weight of edges to be cut when elements are grouped into two groups. Further, “3” means the number of interactions of the Ising model.

The right diagram of FIG. 2 is a diagram schematically illustrating an interaction. The interaction of the right diagram illustrates an example of being received from three of front and back (±1) elements and an eight-previous (−8) element. Note that the interaction of the max-cut 3 with N=16 is not limited to this example.

Hereinafter, a combination optimization problem processing device according to an embodiment of the present invention will be described with an example of solving the combination optimization problem illustrated in FIG. 2.

### First Embodiment

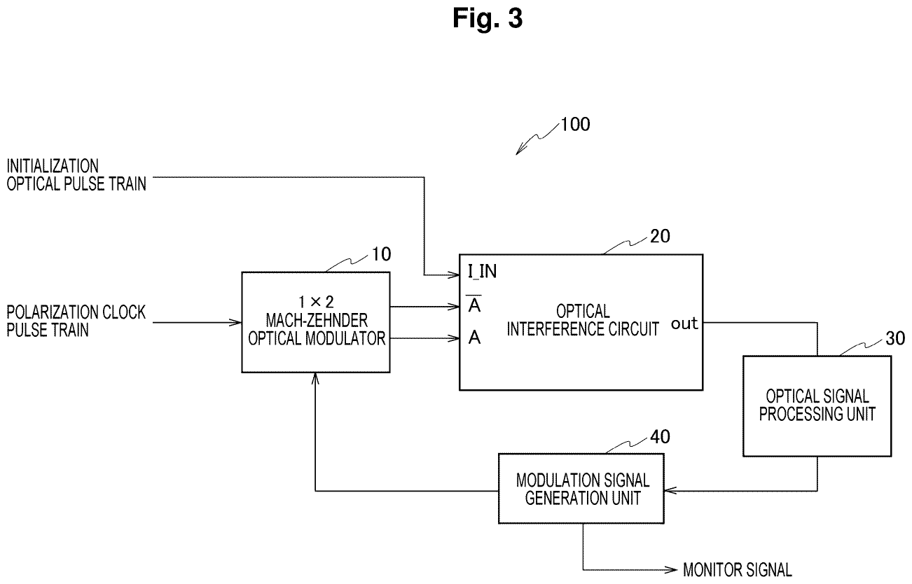

FIG. 3 is a diagram illustrating an example of a configuration of a combination optimization problem processing device according to a first embodiment. A combination optimization problem processing device 100 illustrated in the drawing includes a 1-input 2-output type Mach-Zehnder optical modulator 10 (hereinafter referred to as a Mach-Zehnder optical modulator 10), an optical interference circuit 20, an optical signal processing unit 30, and a modulation signal generation unit 40.

The Mach-Zehnder optical modulator 10 receives an input of a polarized coherent clock pulse train (hereinafter referred to as a polarization clock pulse train). The Mach-Zehnder optical modulator 10 adjusts a fixed phase condition such that the following equation (2) holds.

$$\begin{matrix}[ Math . 2 ] & \\ {ϕ}_{i + N} = {sin}^{2} ( π {ϕ}_{i} ) & ( 2 )\end{matrix}$$

Here, i is a number allocated to an arbitrarily determined reference pulse, and N is a problem scale. In the case of the combination optimization problem of FIG. 2, N=16.

In general, in the Mach-Zehnder optical modulator, a condition that two output ports become A and A with a bar thereon (hereinafter represented as A⁻) is not satisfied due to a manufacturing error or the like. Therefore, a phase adjustment unit capable of adjusting a phase is provided in one or both of arms of an interference device to perform adjustment. When the equation (2) holds, the outputs from the two output ports satisfy the condition of A and A⁻.

The polarization clock pulse train is supplied to the Mach-Zehnder optical modulator 10 in a state where a regression time in the entire main path is matched with a pulse interval dₜ of a problem scale N×the polarization clock pulse train. The polarization clock pulse train is modulated by the Mach-Zehnder optical modulator 10, and the outputs of A and A⁻ from the Mach-Zehnder optical modulator 10 are input to the optical interference circuit 20. The regression time is a time from a time point at which a specific optical pulse is in a state of being to be modulated by the Mach-Zehnder optical modulator 10 to a time point at which an electric pulse derived from the pulse reaches the Mach-Zehnder optical modulator 10 and is modulated and driven.

In the present embodiment, each pulse i of the polarization clock pulse train is associated with each element of the combination optimization problem. Then, a set of N=16 pulses according to the equation (2) can be regarded as one series. Specifically, i, i+N, i+2N, . . . is one series, and (i+1), (i+1)+N, (i+1)+2N, . . . is another series. There are N series up to (i+(N−1)), (i+(N−1))+N, (i+(N−1))+2N, . . . in total.

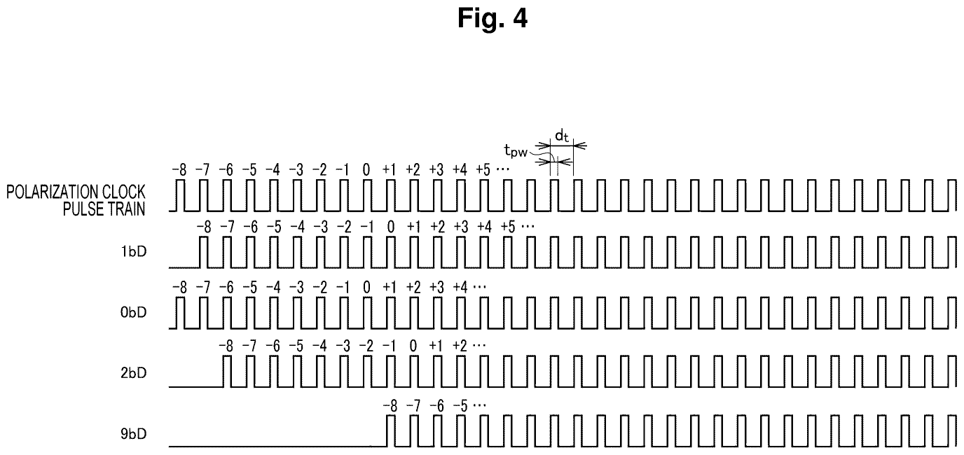

FIG. 4 illustrates a time chart for describing the relationship between the polarization clock pulse train and each series. FIG. 4 illustrates the polarization clock pulse train and four series of pulse trains in a vertical arrangement. Specifically, the first pulse train is the polarization clock pulse train input to, for example, A⁻ of the optical interference circuit 20. The second pulse train is a pulse train 1bD in which the polarization clock pulse train is delayed by one pulse of a polarization clock pulse. The third pulse train is a pulse train 0bD in which the polarization clock pulse train is not delayed. The fourth pulse train is a pulse train 2bD in which the polarization clock pulse train is delayed by two pulses. The fifth pulse train is a pulse train 9bD in which the polarization clock pulse train is delayed by nine pulses. For clarity of description, identification numbers −8, −7, −6, . . . , −1, 0, +1, +2, +3, . . . are assigned from the left of the polarization clock pulse train. Note that a pulse width of the polarization clock pulse train is t_{pw}, the pulse interval is dₜ, and effective peak power is Pₒₚₜ.

Here, attention is paid to the pulse of the identification number 0 of the pulse train 1bD. The pulse with the identification number 0 is the first pulse when viewed in units of cycles of N pulses. The identification numbers of the pulses of the other pulse trains 0bD, 2bD, and 9bD at the same timing as the first pulse are +1, −1, and −8, respectively. That is, the pulse of +1 that is one pulse ahead, the pulse of −1 that is one pulse behind, and the pulse of −8 that is eight pulses behind match with the pulse with the identification number 0 at the same timing.

It is possible to cause an interaction Q_{AF} expressed by the following equation to occur by causing these polarization pulses to interfere with one another by the optical interference circuit 20.

$$\begin{matrix}[ Math . 3 ] & \\ {Q}_{AF : i} = {\sum }^{i \neq k} {J}_{i : k} ( \sqrt{{ϕ}_{i}} - \sqrt{( 1 - {ϕ}_{i + k} )} ) & ( 3 )\end{matrix}$$

Here, i is a serial number of the pulse constituting the polarization clock pulse train, k is a number representing a position of the pulse among the N pulses, and J_{i:k} is a coefficient representing the magnitude of the interaction. Note that the second term in parentheses on the right side of the equation (3) corresponds to A⁻ output from the output port of the Mach-Zehnder optical modulator 10. The equation (3) represents an antiferromagnetic interaction.

In the above example, k is plural. For example, k=+1, k=−1, and k=−8. A value of k corresponds to the interaction illustrated in the right diagram of FIG. 2.

The power of the polarization clock pulse train output from the optical interference circuit 20 can be expressed by the following equation.

$$\begin{matrix}[ Math . 4 ] & \\ {ϕ}_{i + N} = {sin}^{2} π {\vert \sqrt{{ϕ}_{i}} - {Q}_{AF : i} \vert}^{2} & ( 4 )\end{matrix}$$

As described above, by inputting the output optical pulse derived from the polarization clock pulse train from the Mach-Zehnder optical modulator 10 to the optical interference circuit 20, it is possible to generate an optical signal pulse train affected by a desired interaction.

### (Optical Interference Circuit)

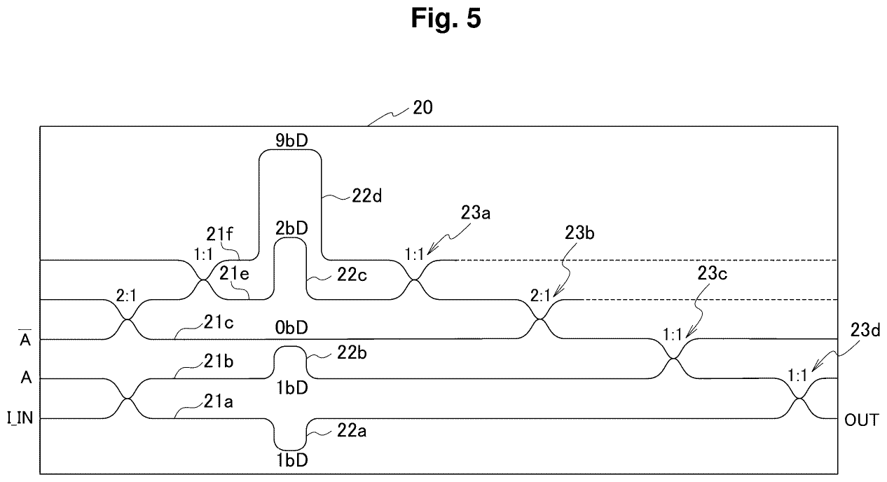

FIG. 5 is a diagram illustrating an example of a configuration of the optical interference circuit 20. The optical interference circuit 20 illustrated in FIG. 5 includes a first delay unit 22a, a second delay unit 22b, a third delay unit 22c, and a fourth delay unit 22d that are a plurality of delay units, a first main path 21a, a second main path 21b, a first action path 21c, a second action path 21e, and a third action path 21f that are a plurality of optical waveguides, and a first optical coupler 23a, a second optical coupler 23b, a third optical coupler 23c, and a fourth optical coupler 23d that are a plurality of optical couplers.

The first delay unit 22a delays the polarization clock pulse train obtained by branching the polarization clock pulse train (A) output from the Mach-Zehnder optical modulator 10 by one pulse. The first main path 21a propagates the first polarization clock pulse train 1bD obtained by delaying the polarization clock pulse train (A) by one pulse.

The second delay unit 22b delays the polarization clock pulse train obtained by branching the polarization clock pulse train (A) output from the Mach-Zehnder optical modulator 10 by one pulse that is the same as the first delay unit. The second main path 21b propagates the second polarization clock pulse train 1bD obtained by delaying the polarization clock pulse train (A) by one pulse.

The first action path 21c propagates the third polarization clock pulse train 0bD obtained by branching the polarization clock pulse train (A⁻) output from the Mach-Zehnder optical modulator 10 as it is.

The third delay unit 22c delays the polarization clock pulse train obtained by branching the polarization clock pulse train (A⁻) output from the Mach-Zehnder optical modulator 10 by two pulses. The second action path 21e propagates the fourth polarization clock pulse train 2bD obtained by delaying the polarization clock pulse train (A⁻) by two pulses.

The fourth delay unit 22d delays the polarization clock pulse train obtained by branching the polarization clock pulse train (A⁻) by nine pulses. The third action path 21f propagates the fifth polarization clock pulse train 9bD obtained by delaying the polarization clock pulse train (A⁻) by nine pulses.

The first optical coupler 23a causes the fifth polarization clock pulse train 9dD and the fourth polarization clock pulse train 2bD to interfere with each other so as to add their amplitudes. The second optical coupler 23b causes an output optical signal of the first optical coupler 23a and the third polarization clock pulse train 0bD to interfere with each other so as to add the amplitudes. The third optical coupler 23c causes the output optical signal of the second optical coupler 23b and the second polarization clock pulse train 1bD to interfere with each other so as to subtract the amplitudes. The fourth optical coupler 23d causes the output optical signal of the third optical coupler 23c and the first polarization clock pulse train 1bD to interfere with each other so as to subtract the amplitudes.

According to the above-described optical interference circuit 20, the interaction illustrated in the right diagram of FIG. 2 can be caused. It is also possible to cause an interaction by a combination of different elements to occur by changing a combination of respective delay amounts of the first delay unit 22a to the fourth delay unit 22d.

Before causing the above-described interaction to occur, an initialization optical pulse train is input to I_IN of the optical interference circuit 20 and coupled to the output signal of the optical interference circuit 20 to create a neutral state in which there is no bias in the magnitude of the mutual relationship of the elements. The initialization pulse train is a pulse train in which the number of pulses is N and the effective peak power Pₒₚₜ/2 is ½ of the effective peak power Pₒₚₜ of the polarization clock pulses. The pulse width t_{pw}, the pulse interval dₜ, and the like other than the effective peak power are the same as those of the polarization clock pulse train.

At the first timing of inputting the initialization optical pulse train, a signal level of the output optical signal of the optical interference circuit 20 is 0. Thus, only the initialization optical pulse train is output from the optical interference circuit 20. When the initialization optical pulse train and the polarization clock pulse train are input in time such that a pulse peak of the modulation signal derived from any pulse of the initialization optical pulse train and a pulse peak of any of the polarization clock pulse train simultaneously reach the Mach-Zehnder optical modulator 10, a neutral state in which the magnitude of the mutual relationship of the elements is 0 is created.

The optical interference circuit 20 creates the neutral state in which the magnitude of the mutual relationship of the elements is 0, using the initialization optical pulse train, and creates the state in which the mutual relationship corresponding to the interaction in the Ising model represented by the equations (3) and (4) occurs between the elements, thereby repeatedly generating a predetermined interaction in the Ising model from the neutral state in a cycle of the N pulses of the polarization clock pulse train. Note that the state of 0 or 1 of the optical pulse train observed with a monitor signal corresponds to the up or down spin state of each lattice point of the Ising model.

Instead of inputting the initialization optical pulse train to the optical interference circuit 20, an optical coupler that couples the output signal of the optical interference circuit 20 and the initialization optical pulse train may be provided at a subsequent stage of the optical interference circuit 20.

### (Optical Signal Processing Unit)

The optical signal processing unit 30 processes the output of the optical interference circuit 20 and inputs the processed output to the modulation signal generation unit 40.

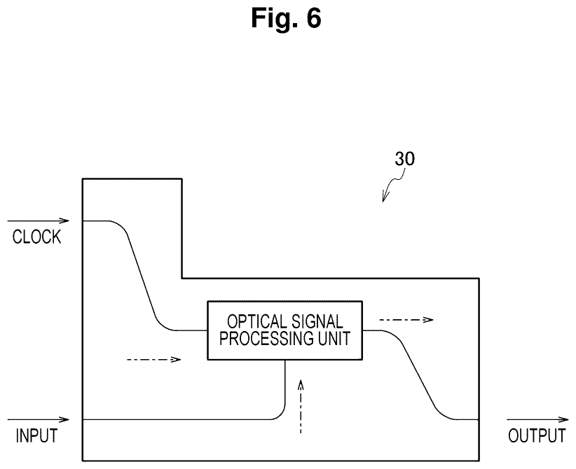

FIG. 6 is a diagram illustrating an example of a configuration of the optical signal processing unit 30. The optical signal processing unit 30 inputs the optical signal pulse train and the polarization clock pulse train output from the optical interference circuit 20, and outputs an optical signal pulse train in which each pulse of the polarization clock pulse train has transitioned with respect to an optical power level according to a power level of each pulse of the input optical signal pulse train. Specifically, the optical signal processing unit 30 outputs the optical signal pulse in a standard optical power region (between 0 and 1) and derived from the optical clock pulse train such that the optical power level transitions closer to 0 when Pn:in <0.5 and transitions closer to 1 when Pn:in >0.5, with the input power level of the standard optical power Pn=0.5 as a demarcation point.

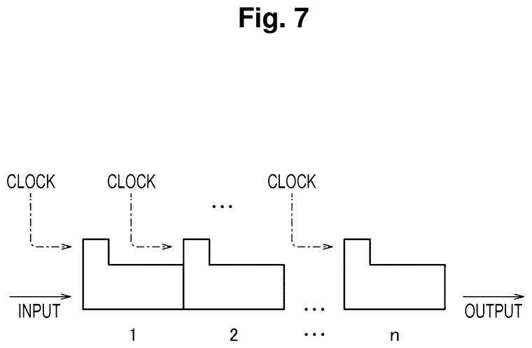

The optical signal processing unit 30 in FIG. 6 connects an appropriate number of stages in a cascade as illustrated in FIG. 7. For example, in a case of a system in which N=100, total coupling, J_{i:k} has a constant absolute value, and ferromagnetic and antiferromagnetic interactions are randomly allocated, the four-stage optical signal processing units 30 are connected in a cascade.

Note that a delay caused by the insertion of the optical signal processing unit 30 is adjusted as a whole so as not to change an operation clock of the entire combination optimization problem processing device 100, or a clock length of the entire combination optimization problem processing device 100 is adjusted and operated on a premise of the delay caused by the insertion of the optical signal processing unit 30.

By inserting the optical signal processing unit 30 into the subsequent stage of the optical interference circuit 20, it is improved so that the power level of the optical signal pulse from a solver (optical interference circuit 20) can be appropriately transitioned to the standard level of 0 or 1 within a range of a practical number of processing steps. As a result, it is possible to obtain an optical pulse pattern output corresponding to a desired “energy stable state of the Ising model”, and it is possible to obtain a solution even in a region with a large interaction in which a sum of the absolute values of J_{i:k} is close to 1 within a range not exceeding 1.

### (Modulation Signal Generation Unit)

The modulation signal generation unit 40 shapes a waveform of an electrical signal obtained by photoelectrically converting the optical signal pulse processed by the optical signal processing unit 30 to generate a modulation signal of the Mach-Zehnder optical modulator 10, and outputs a monitor signal representing a solution to an optimization problem to the outside.

The modulation signal generation unit 40 includes, for example, a photoelectric conversion unit, a preamplifier, a vessel filter, a power splitter, and a post-amplifier. The photoelectric conversion unit photoelectrically converts the optical signal pulse train into a pulse train of an electrical signal. The preamplifier amplifies the pulse train of the electrical signal. The vessel filter is a type of low pass filter and widens the pulse width. The power splitter outputs the monitor signal obtained by tapping the pulse train output from the vessel filter to the outside. An output signal of the power splitter is amplified by the post-amplifier and connected to a modulation terminal of the Mach-Zehnder optical modulator 10.

The polarization clock pulse train is input to the Mach-Zehnder optical modulator 10 in synchronization with the timing when the first pulse of the initialization optical pulse train reaches the modulation terminal of the Mach-Zehnder optical modulator 10. At this time, the timing of the pulse constituting the polarization clock pulse train is adjusted so as to be approximately at a center of a range of the pulse width of the initialization pulse signal expanded by the vessel filter. The mutual timing adjustment may be performed in either the polarization clock pulse train or the initialization optical pulse train.

When the polarization clock pulse train is input to the Mach-Zehnder optical modulator 10 at such timing, the neutral state (symmetric state) in which the magnitude of the mutual relationship between the elements corresponding to the respective series of N=16 pulses is 0 is generated. Thereafter, the above interaction naturally and spontaneously occurs in the optical interference circuit 20 due to “fluctuation” of noise or the like, thereby causing a phenomenon in which symmetry is broken and a stable state in a case where the model is regarded as an Ising model is created.

As described above, it is possible to obtain a solution of a combination optimization problem by reading the stable state in the case where the model is regarded as the Ising model that has appeared due to an emergent phenomenon beyond so-called reductive understanding.

### Second Embodiment

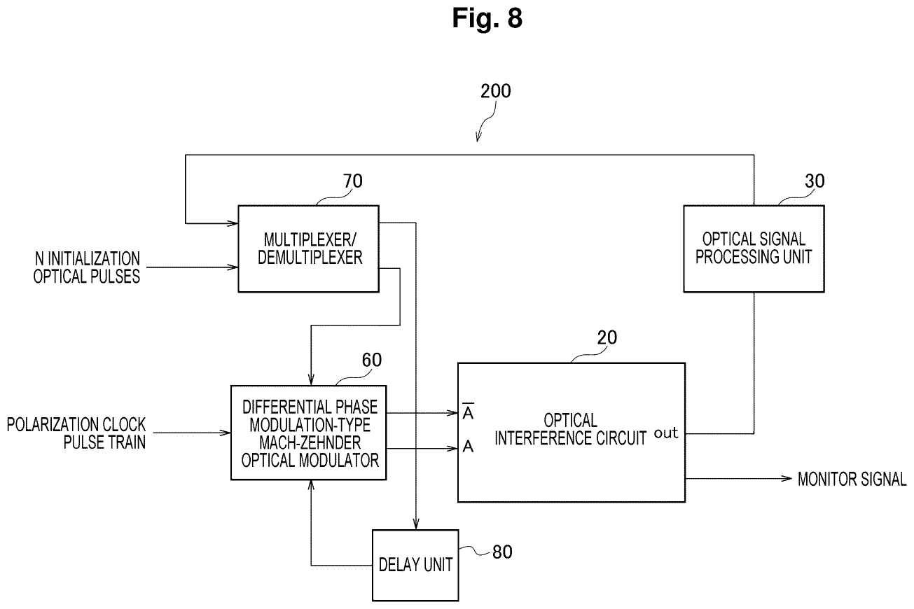

FIG. 8 is a diagram illustrating an example of a configuration of a combination optimization problem processing device according to a second embodiment. A combination optimization problem processing device 200 illustrated in the drawing includes a differential phase modulation-type Mach-Zehnder optical modulator 60, an optical interference circuit 20, an optical signal processing unit 30, a multiplexer/demultiplexer 70, and a delay unit 80. Since the optical interference circuit 20 and the optical signal processing unit 30 are similar to those of the first embodiment, description thereof is omitted here.

The differential phase modulation-type Mach-Zehnder optical modulator 60 receives a polarization clock pulse train as an input. The differential phase modulation-type Mach-Zehnder optical modulator 60 adjusts a fixed phase condition so that the equation (2) described in the first embodiment holds. The polarization clock pulse trains of A and A-modulated by the differential phase modulation-type Mach-Zehnder optical modulator 60 and output from two output ports are input to the optical interference circuit 20.

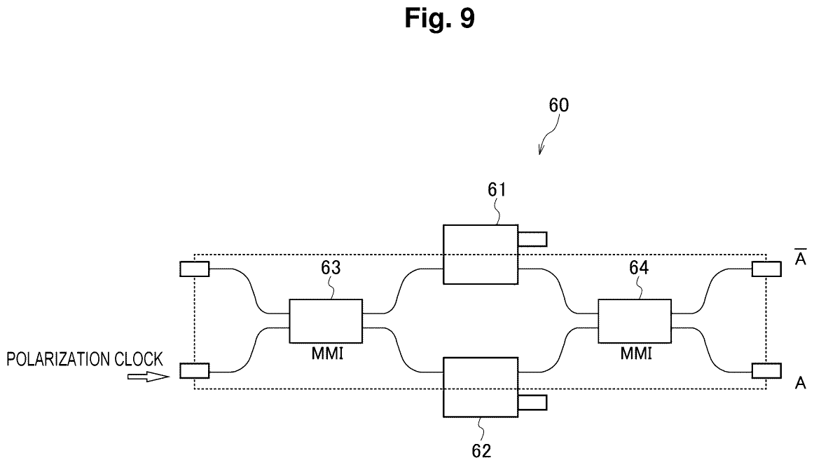

The differential phase modulation-type Mach-Zehnder optical modulator 60 includes a first phase modulation unit and a second phase modulation unit, and s the same as the Mach-Zehnder interference-type optical intensity modulation unit MZ-1 described in Japanese Patent No. 5632330. FIG. 9 illustrates an example of a configuration of the differential phase modulation-type Mach-Zehnder optical modulator 60. As illustrated in FIG. 9, the differential phase modulation-type Mach-Zehnder optical modulator 60 includes two multimode interference units (MMI) 63 and 64, a first phase modulation unit 61, and a second phase modulation unit 62.

The polarization clock pulse train input to the MMI 63 is output to one (A⁻) of the outputs of the MMI 64 under a phase condition in a basic state of the differential phase modulation-type Mach-Zehnder optical modulator 60. At this time, when a modulation signal for exactly shifting the previous phase condition by n is input to the first phase modulation unit 61, the state is switched to a state of being output to one (A) of the outputs of the MMI 64, and the differential phase modulation-type Mach-Zehnder optical modulator 60 becomes an open state. This open state is pulled back to the state of being output to one (A⁻) of the outputs of the MMI 64 when the modulation signal that exactly pulls back the phase condition by π is input to the second phase modulation unit 62, and the differential phase modulation-type Mach-Zehnder optical modulator 60 returns to a closed state.

That is, the differential phase modulation-type Mach-Zehnder optical modulator 60 becomes the open state when the modulation signal is input to the first phase modulation unit 61, and becomes the close state when the modulation signal is input to the second phase modulation unit 62. Configuration and operation of the differential phase modulation-type Mach-Zehnder optical modulator 60 are described in Japanese Patent No. 5632330. Here, further description is omitted.

The optical interference circuit 20 receives the polarization clock pulse train modulated by the differential phase modulation-type Mach-Zehnder optical modulator 60 as an input, causes a predetermined interaction in an Ising model to occur in a cycle of N pulses of the polarization clock pulse train, and outputs a monitor signal the above of representing solution 41 the combination optimization problem to an outside. A signal output from a terminal not denoted as OUT of a fourth optical coupler 23d in FIG. 7 is the monitor signal. The monitor signal represents the solution to the optimization problem.

Similarly to the first embodiment, the optical signal processing unit 30 is inserted into a subsequent stage of the optical interference circuit 20. The optical signal processing unit 30 inputs an optical signal pulse train, and outputs an optical signal pulse train that has undergone a transition according to a power level of each pulse of the input optical signal pulse train. Note that, in the example of FIG. 8, the optical signal processing unit 30 is inserted between the optical interference circuit 20 and the multiplexer/demultiplexer 70, but the optical signal processing unit 30 may be inserted between the multiplexer/demultiplexer 70 and the delay unit 80 or between the delay unit 80 and the differential phase modulation-type Mach-Zehnder optical modulator 60.

The multiplexer/demultiplexer 70 receives, as an input, N initialization optical pulses that create a neutral state for the interaction between elements and the optical signal pulse train from the optical interference circuit 20 and provides two demultiplexing outputs for any of the above inputs. One optical signal pulse demultiplexed by the multiplexer/demultiplexer 70 is input as a drive signal to the first phase modulation unit 61 of the differential phase modulation-type Mach-Zehnder optical modulator 60, and the other optical signal pulse is input to the delay unit 80. The optical signal pulse delayed in the delay unit 80 is output as a drive signal to the second phase modulation unit 62 of the differential phase modulation-type Mach-Zehnder optical modulator 60.

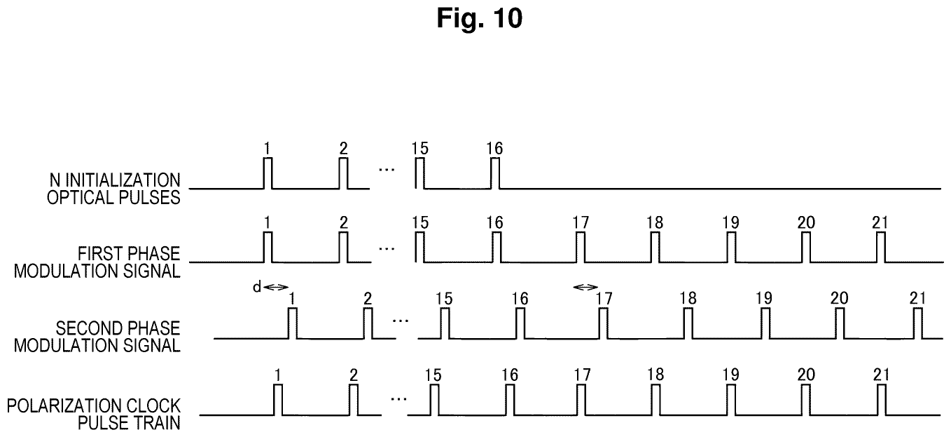

FIG. 10 is a diagram illustrating a relationship among the N initialization optical pulses, a first phase modulation signal, a second phase modulation signal, and the polarization clock pulse train. Note that FIG. 10 is a diagram illustrating only the timing of each signal, and amplitude has no meaning.

The first phase modulation signal is switched to the polarization clock pulse train after the N initialization optical pulses. Therefore, the first phase modulation after the (i=17)th pulses coincides with timing of the polarization clock pulse.

The second phase modulation signal via the delay unit 80 is timing delayed by the delay time d with respect to the first phase modulation signal. The delay time d is equal to or longer than a pulse width of the pulse of the polarization clock pulse train and sufficiently narrower than a pulse interval.

When the first phase modulation signal and the second phase modulation signal shifted by the delay time d are input, the differential phase modulation-type Mach-Zehnder optical modulator 60 becomes the open state only during the delay time d. By inputting the polarization clock pulse train in accordance with the timing of the open state, the polarization clock pulse train outputs a differential phase modulation output according to power of a feedback signal and an initialization signal from the differential phase modulation-type Mach-Zehnder optical modulator 60 to the optical interference circuit 20.

When the polarization clock pulse train is input to the optical interference circuit 20 at such timing, the neutral state (symmetrical state) in which magnitude of a relationship between elements is 0 is generated for each series of N=16 pulses. Thereafter, the above interaction occurs in the optical interference circuit 20, so that a phenomenon in which symmetry is broken and a stable state of the Ising model is created occurs. As described above, it is possible to obtain the solution of the combination optimization problem by reading a state corresponding to the Ising model in the stable state that has appeared due to an emergent phenomenon beyond so-called reductive understanding.

### Third Embodiment

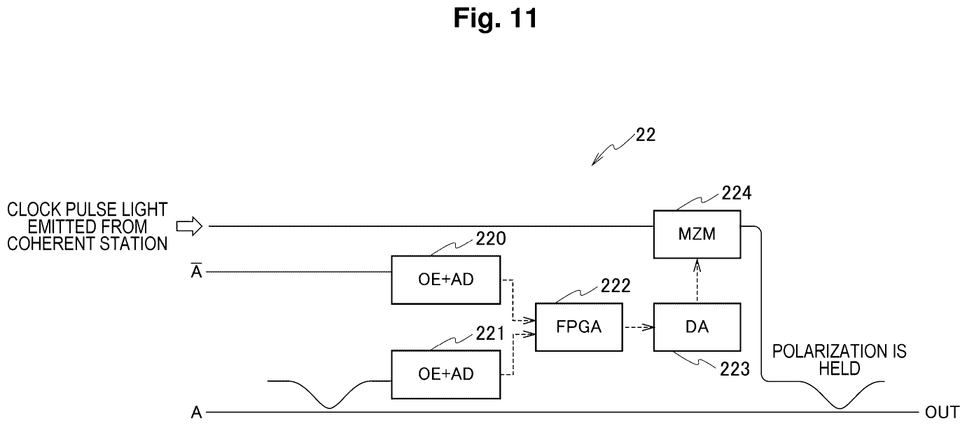

A third embodiment is a combination optimization problem processing device including a functional circuit unit 22 of FIG. 11 instead of the optical interference circuit 20 of the first or second embodiment. Since other components are similar to those of the first embodiment or the second embodiment, an overall configuration diagram of the combination optimization problem processing device of the third embodiment is omitted.

In the functional circuit unit 22 illustrated in FIG. 11, an optical interference circuit 20 includes an FPGA and a Mach-Zehnder optical modulator. The functional circuit unit 22 illustrated in the drawing includes photoelectric AD conversion units 220 and 221, an FPGA 222, a DA conversion unit 223, and a Mach-Zehnder optical modulator (MZM) 224.

The photoelectric AD conversion unit 220 performs AD conversion for an electrical pulse signal obtained by photoelectrically converting a polarization clock pulse train (A⁻), and the photoelectric AD conversion unit 221 performs AD conversion for an electrical pulse signal obtained by photoelectrically converting a polarization clock pulse train (A).

The FPGA 222 digitally processes calculation of the above-described interaction (FIG. 2). An output signal of the FPGA 222 is DA-converted and connected to a modulation signal terminal of the Mach-Zehnder optical modulator 224.

The Mach-Zehnder optical modulator 224 modulates intensity of a clock pulse light emitted from a coherent station with the output signal of the FPGA 222. The clock pulse light emitted from a coherent station can be provided as a pulse train obtained by branching the polarization clock pulse train using a directional coupler (not illustrated).

An OUT terminal corresponds to an OUT terminal of the optical interference circuit 20. As described above, the optical interference circuit can be configured using a semiconductor integrated circuit such as an FPGA. Here, the optical interference circuit 20 and the functional circuit unit 22 are also referred to as an Ising model calculation unit.

### [Comparative Simulation]

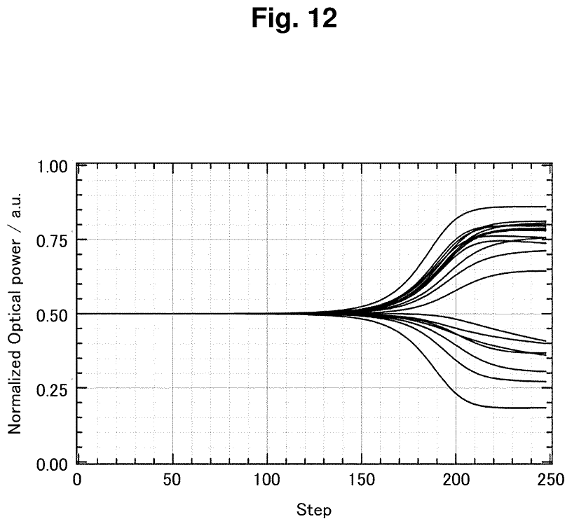

Examples of numerical calculation simulation by the combination optimization problem processing devices of Patent Literatures 1 and 2 are illustrated in FIGS. 12 to 15.

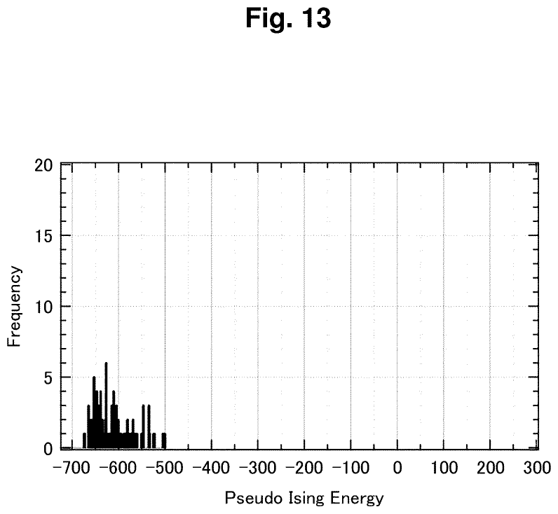

FIGS. 12 and 13 are an example of numerical calculation simulation in the case where the absolute value of J_{i:k} is near 0.004. FIG. 12 is a graph of a change in output optical signal peak power with respect to a step, where the vertical axis represents the normalized output optical signal peak power and the horizontal axis represents a solution search step. FIG. 13 is a graph illustrating an appearance frequency focusing on Ising energy of a search solution.

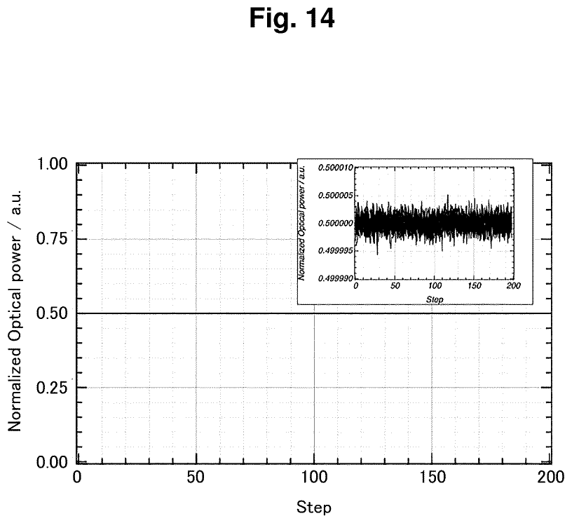

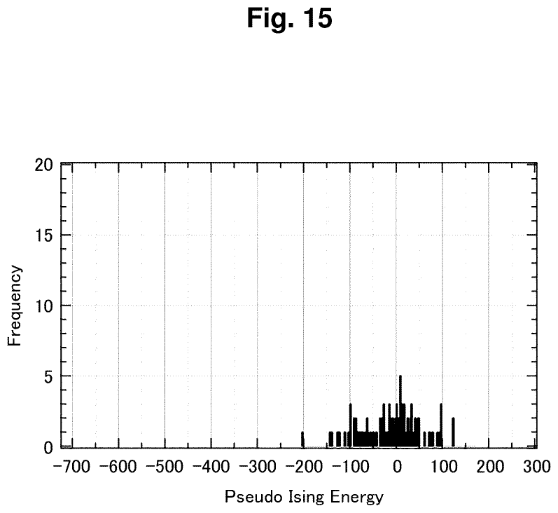

FIGS. 14 and 15 are an example of numerical calculation simulation in the case where the absolute value of J_{i:k} is near 0.009. FIG. 14 is a graph of a change in output optical signal peak power with respect to a step, where the vertical axis represents the normalized output optical signal peak power and the horizontal axis represents a solution search step. FIG. 15 is a graph illustrating an appearance frequency focusing on Ising energy of a search solution.

In the case where the absolute value of J_{i:k} is near 0.004, an expected signal output is obtained, and a generally good solution is obtained as indicated by the appearance frequency focusing on the Ising energy of the search solution in FIG. 13. However, in the case where the absolute value of J_{i:k} is near 0.009, standard peak power of the optical pulse assumed as each Ising lattice point does not transition to a level of 1 and 0 assumed as up and down of Ising spin, and as a result, the good solution cannot be obtained at all as indicated by the appearance frequency focusing on the Ising energy of the search solution in FIG. 15.

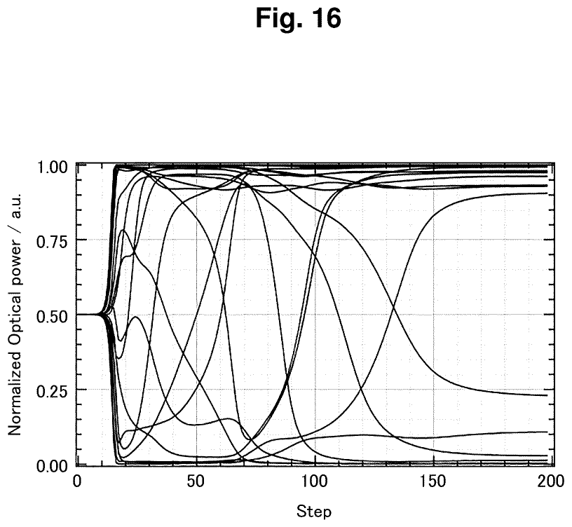

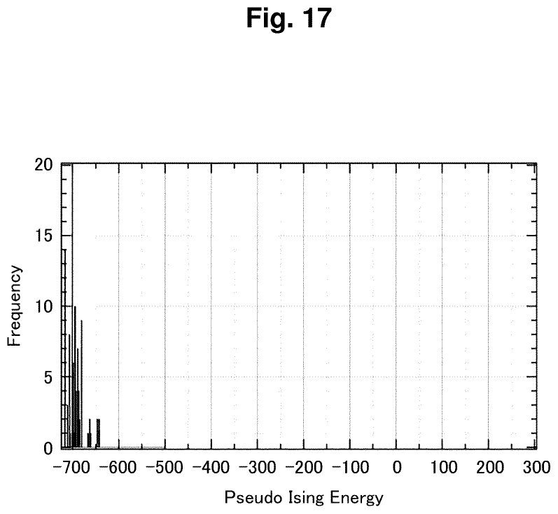

Next, an example of numerical calculation simulation by the combination optimization problem processing device 100 of the present embodiment is illustrated in FIGS. 16 and 17.

FIGS. 16 and 17 are an example of numerical calculation simulation in the case where the absolute value of J_{i:k} is near 0.009. FIG. 16 is a graph of a change in output optical signal peak power with respect to a step, where the vertical axis represents the normalized output optical signal peak power and the horizontal axis represents a solution search step. FIG. 17 is a graph illustrating an appearance frequency focusing on Ising energy of a search solution.

As illustrated in FIG. 16, even in the case where the absolute value of J_{i:k} is near 0.009, in the present embodiment, the standard peak power of the optical pulse assumed as each Ising lattice point transitions to the level of 1 and 0 assumed as up and down of the Ising spin, and at the same time, as indicated by the appearance frequency focusing on the Ising energy of the search solution in FIG. 17, it is possible to obtain a solution better than the solution obtained in the case where the absolute value of J_{i:k} is near 0.004 according to Patent Literatures 1 and 2.

As described above, according to the present embodiment, by including the optical signal processing unit 30 at the subsequent stage of the optical interference circuit 20 of the combination optimization problem processing device 100 or 200, the optical signal processing unit 30 causing each pulse of the polarization clock pulse train to transition with respect to the optical power level according to the power level of each pulse of the optical signal pulse train output from the optical interference circuit 20, it is possible to obtain the optical pulse pattern output corresponding to the energy stable state of the desired Ising model, and it is possible to obtain a good solution in a region with a large interaction in which the sum of the absolute values of the coefficient J_{i:k} representing the magnitude of the interaction is close to 1 within a range not exceeding 1.

The present invention is not limited to the above embodiments, and modifications can be made within the scope of the gist of the present invention. Although the max-cut 3 problem with N=16 has been exemplified as the combination optimization problem, the present invention is not limited to this example. The present invention can be applied to any problem as long as the combination optimization problem can be mapped so as to correspond to the energy of the Ising model. Further, the interaction of the max-cut 3 problem with N=16 is also not limited to the above example.

### REFERENCE SIGNS LIST

100, 200 Combination optimization problem processing device
10 1-input 2-output Mach-Zehnder optical modulator
20 Optical interference circuit
30 Optical signal processing unit
40 Modulation signal generation unit
60 Differential phase modulation-type Mach-Zehnder optical modulator
70 Multiplexer/demultiplexer
80 Delay unit

1. A combination optimization problem processing device that processes a combination optimization problem of N elements in association with an Ising model, the combination optimization problem processing device comprising:
a 1×2 Mach-Zehnder optical modulator that inputs and modulates a polarization clock pulse train;
an Ising model calculation unit that inputs the polarization clock pulse train modulated by the 1×2 Mach-Zehnder optical modulator and causes a predetermined interaction in the Ising model to occur in a cycle of N pulses of the polarization clock pulse train;
an optical signal processing unit that inputs an optical signal pulse train and the polarization clock pulse train output from the Ising model calculation unit, and outputs an optical signal in which each pulse of the polarization clock pulse train has transitioned with respect to an optical power level according to a power level of each pulse of the input optical signal pulse train; and
a modulation signal generation unit that shapes a waveform of an electrical signal obtained by photoelectrically converting the optical signal after the transition to generate a modulation signal of the 1×2 Mach-Zehnder optical modulator, and outputs a monitor signal representing a solution of the optimization problem to an outside, wherein
the Ising model calculation unit inputs an initialization optical pulse train in which effective peak power is ½ of the polarization clock pulse train and the number of pulses is N, creates a neutral state with respect to an interaction between the elements, and repeatedly causes the predetermined interaction in the Ising model from the neutral state in the cycle of N pulses of the polarization clock pulse train.

2. A combination optimization problem processing device that processes a combination optimization problem of N elements in association with an Ising model, the combination optimization problem processing device comprising:
a differential phase modulation-type Mach-Zehnder optical modulator that includes a first phase modulation unit and a second phase modulation unit, and inputs and modulates a polarization clock pulse train;
an Ising model calculation unit that inputs the polarization clock pulse train modulated by the differential phase modulation-type Mach-Zehnder optical modulator, causes a predetermined interaction in the Ising model to occur in a cycle of N pulses of the polarization clock pulse train, and outputs a monitor signal representing a solution of the optimization problem to an outside;
a multiplexer/demultiplexer that receives, as inputs, N initialization optical pulses that create a neutral state for an interaction between the elements and an optical signal pulse train output from the Ising model calculation unit, couples the initialization optical pulse to the optical signal pulse train, demultiplexes the initialization optical pulse and the optical signal pulse train, outputs one of the demultiplexed initialization optical pulse and optical signal pulse train to the first phase modulation unit as a first phase modulation signal, and outputs the other of the demultiplexed initialization optical pulse and optical signal pulse train to a delay unit as a second phase modulation signal; and
a delay unit that delays the second phase modulation signal with respect to the first phase modulation signal by a time equal to or more than a pulse width of a pulse of the polarization clock pulse train and less than a pulse interval and outputs the second phase modulation signal to the second phase modulation unit, wherein
an optical signal processing unit that inputs the optical signal pulse train and the polarization clock pulse train output from the Ising model calculation unit and outputs an optical signal in which each pulse of the polarization clock pulse train has transitioned with respect to an optical power level according to a power level of each pulse of the input optical signal pulse train is provided in one of between the Ising model calculation unit and the multiplexer/demultiplexer, between the multiplexer/demultiplexer and the delay unit, or between the delay unit and the differential phase modulation-type Mach-Zehnder optical modulator.

3. The combination optimization problem processing device according to claim 1, wherein,
in a case where a serial number of a pulse constituting the polarization clock pulse train is denoted by i, a number representing a position of a pulse within the N pulses is denoted by j, and a coefficient representing magnitude of a predetermined interaction in the Ising model is denoted by J_{i:k}, the predetermined interaction in the Ising model is expressed by the following equation,
$$\begin{matrix}[ Math . 5 ] & \\ {Q}_{AF : i} = {\sum }^{i \neq k} {J}_{i : k} ( \sqrt{{ϕ}_{i}} - \sqrt{( 1 - {ϕ}_{i + k} )} ) & ( 5 )\end{matrix}$$
and power of the polarization clock pulse train output by the Ising model calculation unit is expressed by the following equation.
$$\begin{matrix}[ Math . 6 ] & \\ {ϕ}_{i + N} = {sin}^{2} π {\vert \sqrt{{ϕ}_{i}} - {Q}_{AF : i} \vert}^{2} . & ( 6 )\end{matrix}$$

4. A combination optimization problem processing method executed by a combination optimization problem processing device that processes a combination optimization problem of N elements in association with an Ising model, the combination optimization problem processing method comprising:
modulating a polarization clock pulse train by a 1×2 Mach-Zehnder optical modulator;
inputting the polarization clock pulse train modulated by the 1×2 Mach-Zehnder optical modulator to an Ising model calculation unit to cause a predetermined interaction in the Ising model to occur in a cycle of N pulses of the polarization clock pulse train;
causing each pulse of the polarization clock pulse train to transition with respect to an optical power level according to a power level of each pulse of an optical signal pulse train output from the Ising model calculation unit;
shaping a waveform of an electrical signal obtained by photoelectrically converting an optical signal after the transition to generate a modulation signal of the 1×2 Mach-Zehnder optical modulator, and outputting a monitor signal representing a solution of the optimization problem to an outside; and
by the Ising model calculation unit, inputting an initialization optical pulse train in which effective peak power is ½ of the polarization clock pulse train and the number of pulses is N, creating a neutral state with respect to an interaction between the elements, and repeatedly causing the predetermined interaction in the Ising model from the neutral state in the cycle of N pulses of the polarization clock pulse train.

5. (canceled)

6. The combination optimization problem processing device according to claim 2, wherein,
in a case where a serial number of a pulse constituting the polarization clock pulse train is denoted by i, a number representing a position of a pulse within the N pulses is denoted by j, and a coefficient representing magnitude of a predetermined interaction in the Ising model is denoted by J_{i:k}, the predetermined interaction in the Ising model is expressed by the following equation,
$$\begin{matrix}[ Math . 5 ] & \\ {Q}_{AF : i} = {\sum }^{i \neq k} {J}_{i : k} ( \sqrt{{ϕ}_{i}} - \sqrt{( 1 - {ϕ}_{i + k} )} ) & ( 5 )\end{matrix}$$
and power of the polarization clock pulse train output by the Ising model calculation unit is expressed by the following equation.
$$\begin{matrix}[ Math . 6 ] & \\ {ϕ}_{i + N} = {sin}^{2} π {\vert \sqrt{{ϕ}_{i}} - {Q}_{AF : i} \vert}^{2} . & ( 6 )\end{matrix}$$
